(19) United States
(12) Patent Application Publication
(10) Pub. No.: US 2019/0354175 A1
(43) Pub. Date: Nov. 21, 2019

(54) Eye Enrollment For Head-Mounted Enclosure

(71) Applicants: Nick Torkos, Redwood City, CA (US); Duncan A. McRoberts, Santa Clara, CA (US); Pierric Gimmig, Sunnyvale, CA (US)

(72) Inventors: Nick Torkos, Redwood City, CA (US); Duncan A. McRoberts, Santa Clara, CA (US); Pierric Gimmig, Sunnyvale, CA (US)

(21) Appl. No.: 16/411,785

(22) Filed: May 14, 2019

Related U.S. Application Data
(60) Provisional application No. 62/671,651, filed on May 15, 2018.

(51) Int. Cl. G06F 3/01; G06T 7/73; G06T 15/20; G06T 7/60

(52) U.S. Cl. CPC G06F 3/013; G06T 7/75; G06T 2207/30201; G06T 7/60; G06T 15/20

(57) ABSTRACT

Systems and methods for eye enrollment for a head-mounted enclosure are described. Some implementations may include an image sensor; and a processing apparatus configured to: access a set of images, captured using the image sensor, that depict a face of a user and a head-mounted enclosure that the user is wearing; and determine, based on the set of images, a first position of a first eye of the user relative to the head-mounted enclosure.

### CROSS-REFERENCE TO RELATED APPLICATIONS

This application claims the benefit of U.S. Provisional Application No. 62/671,651, filed on May 15, 2018, entitled “Eye Enrollment for Head-Mounted Enclosure,” the content of which is incorporated herein by reference in its entirety for all purposes.

### TECHNICAL FIELD

This disclosure relates to eye enrollment for head-mounted enclosure.

### BACKGROUND

Head-mounted displays are used to provide virtual reality, augmented reality, and/or mixed reality experiences for users. Head-mounted displays are typically one-size-fits-all. Facial geometries can vary significantly from person to person. Deviations of the positions of the eyes of a user from expected nominal positions relative to a head-mounted display can be a cause of image distortion. Manual adjustments of the shape of a head-mounted display can be made to try to mitigate this source of distortion.

### SUMMARY

Disclosed herein are implementations of eye enrollment for head-mounted enclosure.

In a first aspect, the subject matter described in this specification can be embodied in systems that include an image sensor. The systems include a processing apparatus configured to access a set of images, captured using the image sensor, that depict a face of a user and a head-mounted enclosure that the user is wearing; and determine, based on the set of images, a first position of a first eye of the user relative to the head-mounted enclosure.

In a second aspect, the subject matter described in this specification can be embodied in methods that include capturing a set of images that depict a face of a user and a head-mounted enclosure that the user is wearing; determining, based on the set of images, a first position of a first eye of the user relative to the head-mounted enclosure; and determining, based on the set of images, a second position of a second eye of the user relative to the head-mounted enclosure.

In a third aspect, the subject matter described in this specification can be embodied in systems that include a head-mounted enclosure, including a lens, and a display. The systems include a processing apparatus configured to access a first three-dimensional transform for a first virtual camera associated with a first eye of a user that is wearing the head-mounted enclosure, wherein the first three-dimensional transform has been determined based on a position of the first eye relative to the head-mounted enclosure; access a second three-dimensional transform for a second virtual camera associated with a second eye of the user, wherein the second three-dimensional transform has been determined based on a position of the second eye relative to the head-mounted enclosure; apply the first three-dimensional transform to an image to obtain a first transformed image; project the first transformed image from the display, via the lens of the head-mounted enclosure, to the first eye; apply the second three-dimensional transform to an image to obtain a second transformed image; and project the second transformed image from the display, via the lens of the head-mounted enclosure, to the second eye.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is an illustration of an example of a head-mounted enclosure worn by a user.

FIG. 1B is an illustration of an example of a head-mounted enclosure worn by a user.

FIG. 2 is an illustration of an example of a user wearing a head-mounted enclosure during an eye enrollment process.

FIG. 3 is a block diagram of an example of a system configured to perform an eye enrollment process for a head-mounted enclosure.

FIG. 4 is a block diagram of an example of a system configured to present images to a user via an optical assembly of a head-mounted enclosure, using eye enrollment data.

FIG. 5 is a flowchart of an example of a process for eye enrollment for a head-mounted enclosure.

FIG. 6 is a flowchart of an example of a process for determining a position for one or more eyes of a user relative to a head-mounted enclosure.

FIG. 7 is a flowchart of an example of a process for presenting images to a user via an optical assembly of a head-mounted enclosure, using eye enrollment data.

### DETAILED DESCRIPTION

Computer-generated reality applications may be provided using a head-mounted enclosure that is worn on the head of a user and is configured present images from a display device mounted in the head-mounted enclosure, via an optical assembly (e.g., including a lens and/or a mirror), to the eyes of the user. The relative positions of the display device, the optical assembly, and the eyes of the user affect how a presented image is perceived by the user. For example, an error in assumed eye positions relative to the head-mounted enclosure may alter the perspective and perceived depth of objects appearing in the image and thus distort an intended correspondence between real and virtual objects in a computer-generated reality environment. For example, an error in assumed eye positions relative to the head-mounted enclosure may distort an image presented to the user and negatively affect an ability of the user to mentally fuse images seen by their two eyes (e.g., to enable stereoscopic vision). Accurate position information for the eyes relative to the head-mounted enclosure is thus important aspect of providing high quality computer-generated reality experiences. Because human heads can vary in their geometry significantly between different individuals and head-mounted enclosures can be positioned differently on a user between usage sessions, it is advantageous to efficiently and accurately determine the positions eyes of a user when the user puts on a head-mounted enclosure. Manual calibration techniques for a head-mounted enclosure may include many steps that ask for significant feedback and attentive interaction with the user. These manual calibration processes can be confusing (especially for new users) and can be error prone.

Eye enrollment processes and systems for head-mounted enclosures may be used to efficiently and accurately estimate the positions of a user's eyes relative to a head-mounted enclosure worn by the user. In some implementations, two computing devices are used for eye enrollment. A first computing device captures images depicting both the face of the user and the head-mounted enclosure that is worn by the user. Computer vision and tracking techniques may be used to determine the positions of the eyes relative to the head-mounted enclosure. The resulting eye enrollment data may be used by a second computing device that is mounted in the head-mounted enclosure worn by the user to calibrate the image presentation system of the head-mounted enclosure in order to present high quality images of virtual objects to the user. For example, a three-dimensional transformation may be determined based on eye position and used for adjusting a virtual camera for an eye of the user to better match the position of the eye. For example, a distortion map may be determined based on eye position and used to correct for distortion caused by an optical assembly (e.g., a lens) as viewed from the position of the eye.

Using the described eye enrollment systems and processes can provide advantages over some conventional systems for providing computer-generated reality experiences to users. For example, performing an eye enrollment may improve the quality of computer-generated reality images as perceived by the user. For example, an eye enrollment can conveniently and/or automatically calibrate the virtual object presentation system for a computer-generated reality application. In some implementations, an eye enrollment procedure is largely automated and can be completed quickly.

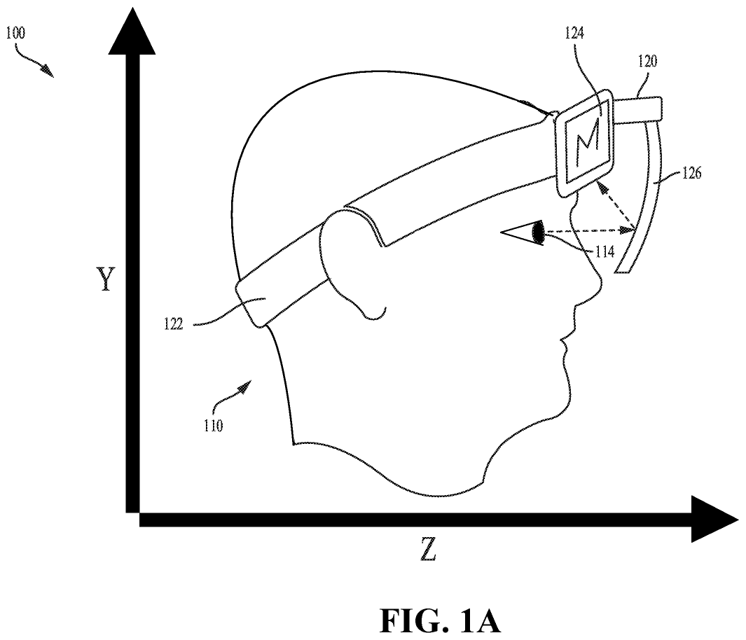

FIGS. 1A and 1B are an illustrations of an example of a head-mounted enclosure worn by a user. FIG. 1A shows a side profile 100 of a user 110 wearing a head-mounted enclosure 120. The head-mounted enclosure 120 includes a fastening article 122, a display device 124, and an optical assembly 126. The fastening article 122 (e.g., including a headband) is configured to hold the head-mounted enclosure 120 in position on a head of the user 110 when worn by the user 110. A coordinate system with reference to the head-mounted enclosure 120 may include three dimensions for specifying the spatial positions of objects, such a right eye 114 of the user 110, relative to the head-mounted enclosure 120. Two of the dimensions of this coordinate system (labeled “Y” and “Z”) are shown in the side profile 100 of FIG. 1A.

The display device 124 is configured to present images that may be viewed by the user via the optical assembly 126. For example, the display device 124 may be a personal computing device (e.g., a smartphone) that is configured to present images on a touchscreen. The display device 124 may removably mounted in the head-mounted enclosure 120. In some implementations, the display device 124 is permanently attached to the head-mounted enclosure 120.

The optical assembly 126 (e.g., a lens and/or a mirror) is configured to direct light from the display device 124 and/or from an environment around the user to eyes of the user 110. For example, the optical assembly 126 may include a partially reflective polarizing film applied to an inner surface of a transparent visor. The optical assembly 126 may function as an optical combiner. A right eye 114 of the user 110 is shown in the side profile 100 of FIG. 1A. For example, light forming an image may be emitted from the display device 124 and be directed to the right eye 114 via the optical assembly 126. In some implementations, the optical assembly 126 includes a mirror that reflects light from the display device 124 to the right eye 114. In some implementations, the optical assembly 126 includes a lens that reflects light from the display device 124 to the right eye 114. For example, a lens of the optical assembly 126 may also let light from an environment in front of the user 110 pass through to reach the right eye 114 and allow the user 110 to see in front of him while having objects depicted in an image presented by the display device 124 overlaid on a view of the physical environment in front of the user 110. In some implementations, a transparency of the optical assembly 126 (e.g., a lens) may be adjusted to suit an application (e.g., a virtual reality application or an augmented reality application).

Accurate position information for eyes of the user 110 may be used to better project an image (e.g., an augmented reality image) from the display device 124 to the right eye 114 via the optical assembly 126. The position of the eyes of the user 110 relative to the head-mounted enclosure 120 affects how an image presented by the display device 124 is perceived by the user. For example, changes in the position of the eyes of the user 110 relative to the head-mounted enclosure 120 may alter the perspective and/or perceived depth of objects appearing in a presented image. Thus knowledge of the eye positions may be used to control presentation of objects to the user, such as at a particular location in an augmented reality space. Errors in estimates of the positions of the eyes may distort a presented image and/or negatively impact an ability of the user 110 to fuse for stereoscopic vision.

FIG. 1B shows a front profile 150 of a user 110 wearing a head-mounted enclosure 120. The front profile 150 shows both the right eye 114 and a left eye 116 of the user 110. A coordinate system with reference to the head-mounted enclosure 120 may include three dimensions for specifying the spatial positions of objects, such a right eye 114 and the left eye 116 of the user 110, relative to the head-mounted enclosure 120. Two of the dimensions of this coordinate system (labeled “Y” and “X”) are shown in the front profile 150 of FIG. 1A. In this example, the optical assembly 126 is temporarily removed or transparent, allowing a view from in front of the user 110 of the display device 124 mounted in the head-mounted enclosure 120. In this example, the display device is presenting a marker 160. This known marker 160 may be detected in a captured image depicting a face of the user 110 (e.g., including the right eye 114 and the left eye 116) and the head-mounted enclosure 120 worn by the user 110. Knowledge of the size and shape of the marker 160 may be used to identify and position and/or orientation of the head-mounted display as it appears in the captured image and facilitate the determination of the positions of the right eye 114 and the left eye 116 relative to the head-mounted enclosure 120.

The positions of the eyes of the user 110 can be determined by a manual calibration process that uses significant fine-grained feedback from the user to detect or adjust for particular eye positions of the user 110 relative to the head-mounted enclosure 120 being worn. However, some manual processes for calibration for eye positions can include several steps, can be confusing for a new user, and/or can be error prone.

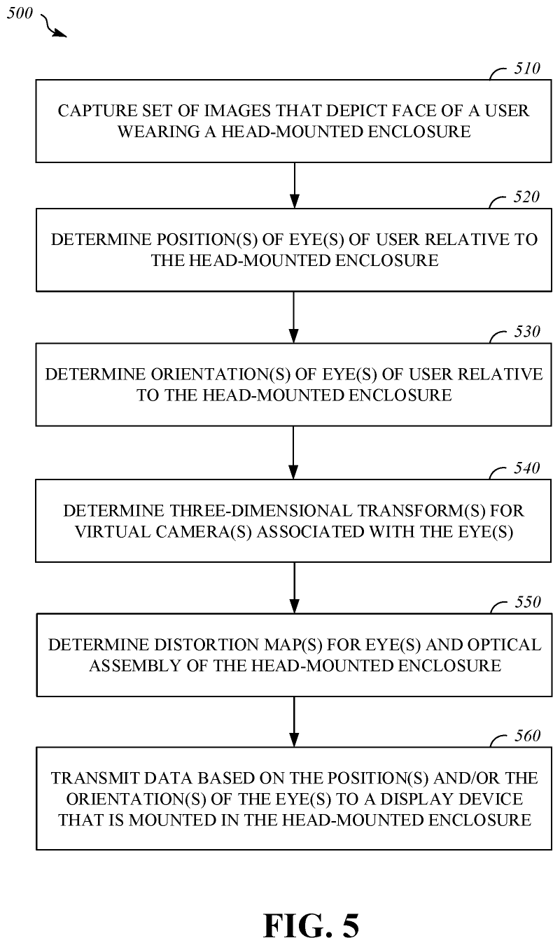

An eye enrollment process may be used to calibrate a system including the head-mounted enclosure 120 worn by the user 110 to present quality images to the via the optical assembly 126 by determining the positions of the eyes of the user 110 relative to the head-mounted enclosure 120 and/or to each other. In some implementations, positions of the right eye 114 and the left eye 116 may be determined as respective offsets relative to a predefined point in the coordinate system of the head-mounted enclosure 120 (e.g., with the axes labeled “X”, “Y”, and “Z” in FIGS. 1A-1B). For example, an eye enrollment process may be performed when the user puts on the head-mounted enclosure 120 at the start of session of use. An eye enrollment process may be operate with less user interaction by capturing images that include both the face, including at least an eye, of the user and the head-mounted enclosure in a field of view of the captured images. The positions of the eyes of the user 110 may be determined based on the captured images and used to calibrate the presentation of images to the user 110 from the display device 124 via the optical assembly 126. For example, eye enrollment may be performed by implementing the process 500 of FIG. 5. In some implementations, a separate device (e.g., a smartphone) is used to capture the images of the face and the head-mounted enclosure 120 worn by the user 110 for eye enrollment. Eye position information may then be transmitted to the display device 124 to complete the calibration to enable quality presentation of images to the user 110. In some implementations, a single device, the display device is used both to capture the images of the face and the head-mounted enclosure 120 worn by the user 110 for eye enrollment and to display images to the user using the resulting calibration data. For example, the display device 124 may include an image sensor that captures the images of the face and the head-mounted enclosure 120 worn by the user 110 for eye enrollment while the display device 124 is held in a hand of the user 110. After capture of these images, the display device 124 may be mounted in place in the head-mounted enclosure 120, as shown in FIG. 1A, and the calibration information generated may be used to enable quality presentation of images to the user 110. In some implementations, the display device includes an image sensor and is configured to perform an eye enrollment process while mounted in the head-mounted enclosure 120, by capturing images of the eyes via reflection off the optical assembly 126 (e.g., including a mirror and/or a lens). Information about eye positions is important good computer-generated reality user experiences. An effective eye enrollment process may obviate the use of complex eye tracking systems that dynamically track eye position and orientation and avoid use additional expensive sensors built into a head-mounted enclosure for eye tracking.

In some implementations (not shown in FIG. 1B), a marker similar to the marker 160 may be implemented as physical feature (e.g., a painted and/or raised symbol) of the head-mounted enclosure, rather than being part of an image presented on a display. For example, a marker feature may be positioned in a slot behind were the display device 124 is mounted in the head-mounted enclosure 120. The marker feature may appear in images captured for eye enrollment before the display device is mounted in the head-mounted enclosure 120 worn by the user 110. For example, this marker feature may be used where the display device 124 includes an image sensor and is used to perform eye enrollment and to present images to the user.

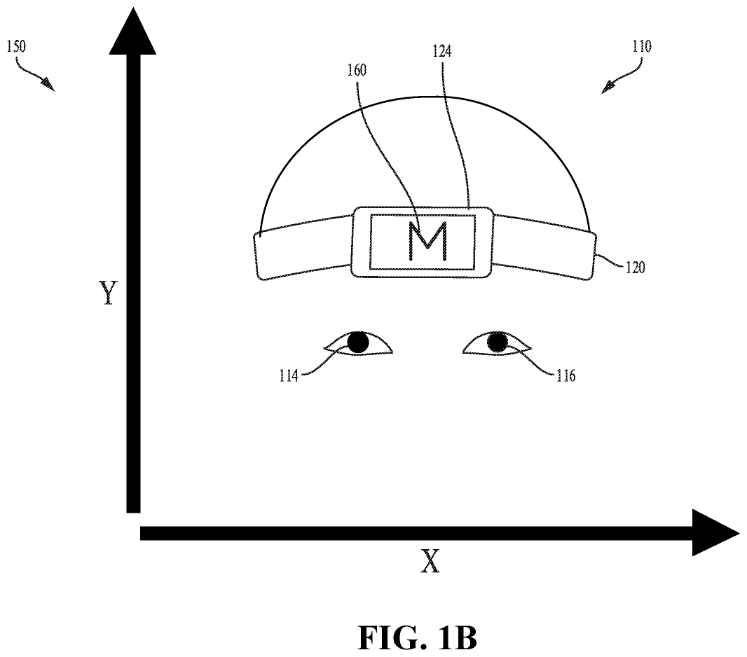

FIG. 2 is an illustration of an example of a user 110 wearing a head-mounted enclosure 120 during an eye enrollment process. In this example, two computing devices (e.g., two smartphones) are used to perform the eye enrollment. A first computing device is the display device 124 that is mounted in the head-mounted enclosure 120 that is worn by the user 110. The display device presents the marker symbol 160 on its display. A second computing device in a personal computing device 230 that is held by the user 110 in a hand 212 of the user. The personal computing device 230 includes one or more image sensors 232 (e.g., sensing infrared and/or visible spectrum light) that are directed at a face of the user 110 while the user is wearing the head-mounted enclosure 120. A set of images is captured using the one or more image sensors 232, where the images depict the face of the user 110 and the head-mounted enclosure 120 that the user is wearing. In some implementations, the user 110 may turn their heads during the eye enrollment process so that the set of images includes a diversity of perspectives of the face and the head-mounted enclosure 120. The set of images captured may be processed with face tracking and marker tracking systems to determine positions of eyes of the user 110 relative to the head-mounted enclosure 120. The set of images captured may processed with face tracking and marker tracking systems to determine orientations of eyes of the user 110 relative to the head-mounted enclosure 120. Data (e.g., eye enrollment data) based on the positions and/or the orientations of the eyes may be transmitted from the personal computing device 230 to the display device 124. The display device 124 may then obtain a three-dimensional transform and/or a distortion map for respective eyes of the user 110 (e.g. the right eye 114 and the left eye 116) that are based on the positions and/or the orientations of the eyes. The three-dimensional transforms and/or a distortion maps may be used to adjust images for presentation via images projected from the display device 124, via the optical assembly 126 (e.g., a lens and/or a mirror), to the eyes of the user. For example, the presented images may be used to implement a computer-generated reality application for the user 110.

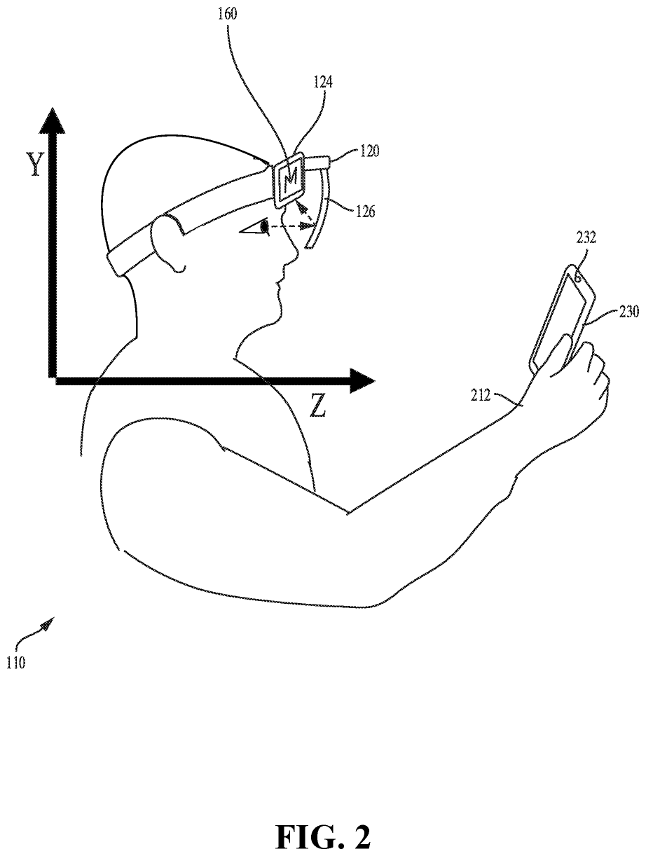

FIG. 3 is a block diagram of an example of a system 300 configured to perform an eye enrollment process for a head-mounted enclosure (e.g., the head-mounted enclosure 120). The system 300 may include a processing apparatus 310, a data storage device 320, an image sensor 330, a wireless communications interface 340, and an interconnect 350 through which the processing apparatus 310 may access the other components. The system 300 may be configured to perform eye enrollment for a user wearing a head-mounted enclosure. For example, the system 300 may be configured to implement the process 500 of FIG. 5. For example the system 300 may be implemented as part of a personal computing device (e.g., a smartphone or a tablet).

The processing apparatus 310 may be operable to execute instructions that have been stored in a data storage device 320. In some implementations, the processing apparatus 310 is a processor with random access memory for temporarily storing instructions read from the data storage device 320 while the instructions are being executed. The processing apparatus 310 may include single or multiple processors each having single or multiple processing cores. Alternatively, the processing apparatus 310 may include another type of device, or multiple devices, capable of manipulating or processing data. For example, the data storage device 320 may be a non-volatile information storage device such as a hard drive, a solid-state drive, a read-only memory device (ROM), an optical disc, a magnetic disc, or any other suitable type of storage device such as a non-transitory computer readable memory. The data storage device 320 may include another type of device, or multiple devices, capable of storing data for retrieval or processing by the processing apparatus 310. For example, the data storage device 320 can be distributed across multiple machines or devices such as network-based memory or memory in multiple machines performing operations that can be described herein as being performed using a single computing device for ease of explanation. The processing apparatus 310 may access and manipulate data stored in the data storage device 320 via interconnect 350. For example, the data storage device 320 may store instructions executable by the processing apparatus 310 that upon execution by the processing apparatus 310 cause the processing apparatus 310 to perform operations (e.g., operations that implement the process 500 of FIG. 5).

The one or more image sensors 330 may be configured to capture images, converting light incident on the image sensor 330 into a digital images. The one or more image sensors 330 may detect light of a certain spectrum (e.g., a visible spectrum and/or an infrared spectrum) and convey information constituting an image as electrical signals (e.g., analog or digital signals). For example, the one or more image sensors 330 may include charge-coupled devices (CCD) or active pixel sensors in complementary metal-oxide-semiconductor (CMOS). In some implementations, the one or more image sensors 330 include an analog-to-digital converter. For example, the one or more image sensors 330 may include an infrared camera and a visible light camera. In some implementations (not shown in FIG. 3), the system 300 includes an illuminator and/or a projector that projects light that may be reflected off objects in a scene and detected by the one or more image sensors 330. For example, the system 300 may include an infrared illuminator.

The wireless communications interface 340 facilitates communication with other devices. For example, wireless communications interface 340 may facilitate communication via a Wi-Fi network, a Bluetooth link, or a ZigBee link. For example, wireless communications interface 340 may facilitate communication via infrared signals, audio signals, or light signals received using computer vision. In some implementations, the wireless communications interface 340 may be used to transmit calibration data resulting from an eye enrollment process to a display device mounted in a head-mounted enclosure (e.g., the display device 124) that will use the calibration data to present images to a user wearing the head-mounted enclosure. For example, the interconnect 350 may be a system bus, or a wired or wireless network.

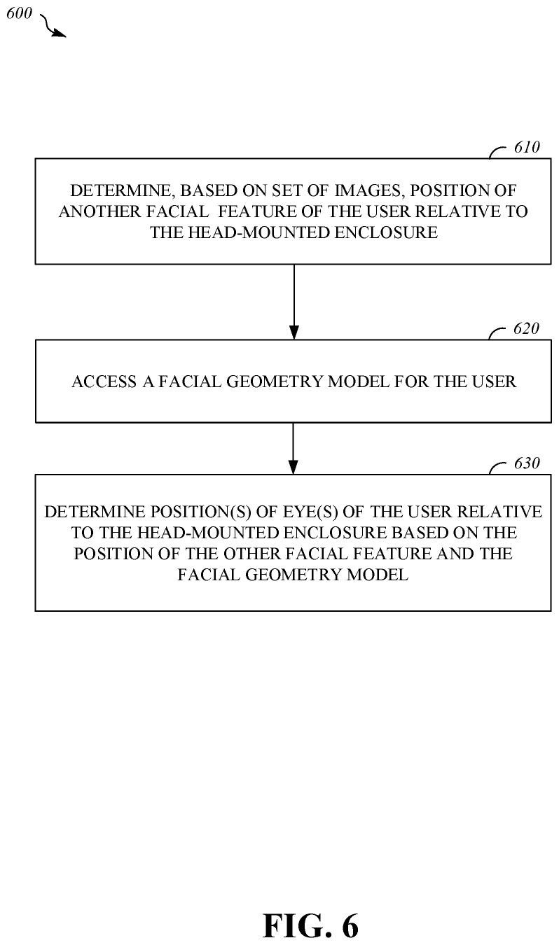

The processing apparatus 310 may be configured to perform an eye enrollment process. For example, the processing apparatus 310 may be configured to access a set of images, captured using the image sensor 330, that depict a face of a user (e.g., the user 110) and a head-mounted enclosure (e.g., the head-mounted enclosure 120) that the user is wearing. The processing apparatus 310 may be configured to determine, based on the set of images, a first position of a first eye (e.g., the right eye 114) of the user relative to the head-mounted enclosure. For example, processing apparatus 310 may implement the process 600 of FIG. 6 to determine the first position. The processing apparatus 310 may be configured to determine, based on the set of images, a second position of a second eye (e.g., the left eye 116) of the user relative to the head-mounted enclosure. For example, processing apparatus 310 may implement the process 600 of FIG. 6 to determine the second position. The processing apparatus 310 may be configured to determine, based on the set of images, a first orientation of the first eye of the user relative to the head-mounted enclosure. The processing apparatus 310 may be configured to determine, based on the first position, a three-dimensional transform for a first virtual camera associated with the first eye. The processing apparatus 310 may be configured to determine, based on the first position, a distortion map for the first eye and an optical assembly (e.g., the optical assembly 126) of the head-mounted enclosure. In some implementations, the processing apparatus 310 may be configured to use the wireless communications interface 340 to transmit data based on the first position to a display device (e.g., the display device 124) that is mounted in the head-mounted enclosure.

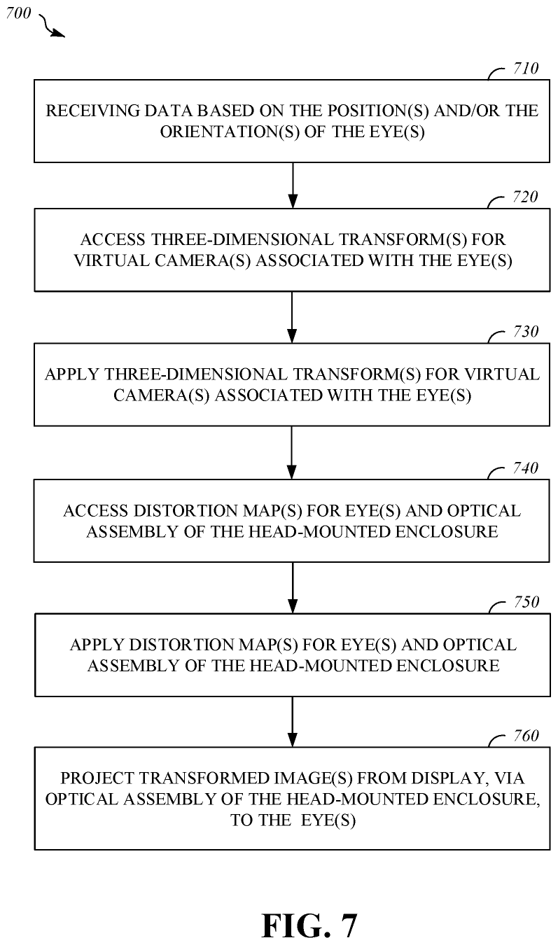

In some implementations (not shown in FIG. 3), the system 300 includes a display and is configured to both perform an eye enrollment process (e.g., the process 500 of FIG. 5) and use resulting calibration data to present (e.g., using the process 700 of FIG. 7) images to the user (e.g., the user 110) wearing the head-mounted enclosure (e.g., the head-mounted enclosure 120). For example, the system 300 may be implemented as part of a smartphone that is first used from a user's hand to perform an eye enrollment process, and then mounted in the head-mounted enclosure worn by the user to provide a computer-generated reality application. For example, the processing apparatus 310 may be configured to apply the three-dimensional transform to an image to obtain a transformed image. The processing apparatus 310 may be configured to project the transformed image from the display, via an optical assembly (e.g., the optical assembly 126) of the head-mounted enclosure, to the first eye (e.g., the right eye 114). For example, the processing apparatus 310 may be configured to apply a transformation based on the distortion map to an image to obtain a transformed image. For example, the processing apparatus 310 may be configured to project the transformed image from the display, via the optical assembly of the head-mounted enclosure, to the first eye.

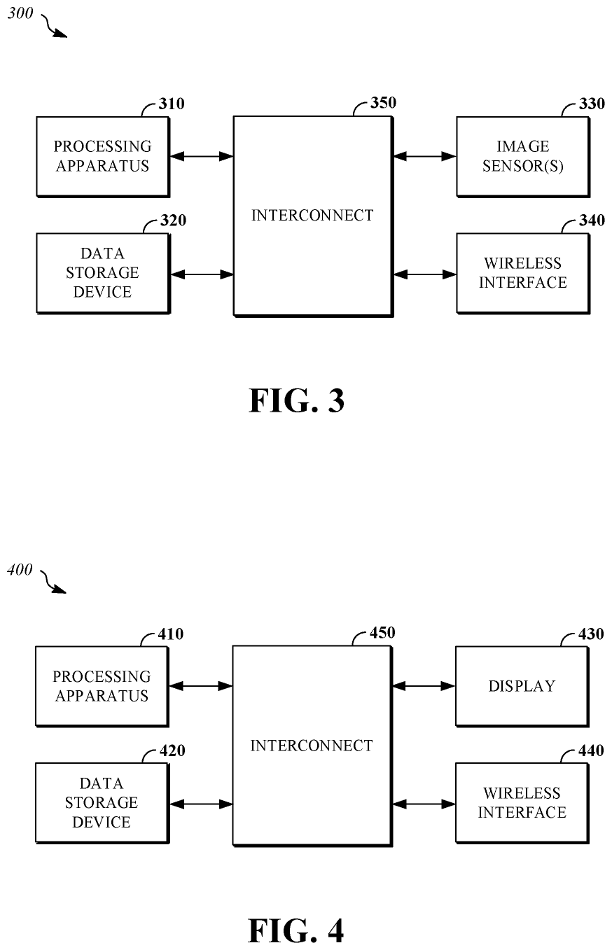

FIG. 4 is a block diagram of an example of a system 400 configured to present images to a user (e.g., the user 110) via an optical assembly (e.g., the optical assembly 126) of a head-mounted enclosure (e.g., the head-mounted enclosure 120), using eye enrollment data. The system 400 may include a processing apparatus 410, a data storage device 420, a display 430, a wireless communications interface 440, and an interconnect 450 through which the processing apparatus 410 may access the other components. The system 400 may be configured to present images to a user wearing a head-mounted enclosure (e.g., to enable a computer-generated reality application), using calibration data from an eye enrollment process. For example, the system 400 may be configured to implement the process 700 of FIG. 7. For example, the system 400 may be implemented as part of a display device (e.g., a smartphone), which may be mounted in or otherwise attached to a head-mounted enclosure.

The processing apparatus 410 may be operable to execute instructions that have been stored in a data storage device 420. In some implementations, the processing apparatus 410 is a processor with random access memory for temporarily storing instructions read from the data storage device 420 while the instructions are being executed. The processing apparatus 410 may include single or multiple processors each having single or multiple processing cores. Alternatively, the processing apparatus 410 may include another type of device, or multiple devices, capable of manipulating or processing data. For example, the data storage device 420 may be a non-volatile information storage device such as a hard drive, a solid-state drive, a read-only memory device (ROM), an optical disc, a magnetic disc, or any other suitable type of storage device such as a non-transitory computer readable memory. The data storage device 420 may include another type of device, or multiple devices, capable of storing data for retrieval or processing by the processing apparatus 410. For example, the data storage device 420 can be distributed across multiple machines or devices such as network-based memory or memory in multiple machines performing operations that can be described herein as being performed using a single computing device for ease of explanation. The processing apparatus 410 may access and manipulate data stored in the data storage device 420 via interconnect 450. For example, the data storage device 420 may store instructions executable by the processing apparatus 410 that upon execution by the processing apparatus 410 cause the processing apparatus 410 to perform operations (e.g., operations that implement the process 700 of FIG. 7).

The display 430 may be configured to present images, converting digital images into light projected from the display 430. The display 430 may project light using an array of pixels that project light in a visible spectrum. For example, the display 430 may include a screen. For example, the display 430 may include a liquid crystal display (LCD), a light emitting diode (LED) display (e.g., an OLED display), or other suitable display. For example, the display 430 may include a projector. In some implementations, the display 430 includes fiber optics.

In some implementations (not shown in FIG. 4), the system 400 may include one or more speakers (e.g., headphones or earbuds). The improved accuracy of the three dimensional position and/or orientation of the head-mounted enclosure may be used to enhance the quality and/or accuracy of stereo sound effects. For example, a spatial location of an object making a sound, Doppler effects if the object is moving relative to your ears, or reverb may be reflected in sound played on the one or more speakers. Even a sound made in a shared environment that others would hear (e.g., a whisper behind a virtual reality character's ear) may be played.

The wireless communications interface 440 facilitates communication with other devices. For example, wireless communications interface 440 may facilitate communication via a Wi-Fi network, a Bluetooth link, or a ZigBee link. In some implementations, the wireless communications interface 440 may be used to receive calibration data resulting from an eye enrollment process from a personal computing device (e.g., the personal computing device 230) that has performed an eye enrollment process for a user (e.g., the user 110) wearing a head-mounted enclosure (e.g., the head-mounted enclosure 120). For example, the interconnect 450 may be a system bus, or a wired or wireless network.

The processing apparatus 410 may be configured to access a first three-dimensional transform for a first virtual camera associated with a first eye (e.g., the right eye 114) of a user (e.g., the user 110) that is wearing the head-mounted enclosure (e.g., the head-mounted enclosure 120). The first three-dimensional transform may have been determined based on a position of the first eye relative to the head-mounted enclosure. The processing apparatus 410 may be configured to access a second three-dimensional transform for a second virtual camera associated with a second eye (e.g., the left eye 116) of the user. The second three-dimensional transform may have been determined based on a position of the second eye relative to the head-mounted enclosure. The processing apparatus 410 may be configured to apply the first three-dimensional transform to an image to obtain a first transformed image. The processing apparatus 410 may be configured to project the first transformed image from the display 430, via a lens (e.g., a lens of the optical assembly 126) of the head-mounted enclosure, to the first eye. The processing apparatus 410 may be configured to apply the second three-dimensional transform to an image to obtain a second transformed image. The processing apparatus 410 may be configured to project the second transformed image from the display 430, via the lens of the head-mounted enclosure, to the second eye. In some implementations, the processing apparatus 410 may be configured to access a first distortion map for the first eye and the lens of the head-mounted enclosure. The processing apparatus 410 may be configured to access a second distortion map for the second eye and the lens of the head-mounted enclosure. The processing apparatus 410 may be configured to apply a transformation based on the first distortion map to an image to obtain the first transformed image. The processing apparatus 410 may be configured to apply a transformation based on the second distortion map to an image to obtain the second transformed image.

FIG. 5 is a flowchart of an example of a process 500 for eye enrollment for a head-mounted enclosure (e.g., the head-mounted enclosure 120). The process 500 includes capturing 510 a set of images that depict a face of a user wearing the head-mounted enclosure; determining 520 positions of one or more eyes of the user relative to the head-mounted enclosure; determining 530 orientations of one or more eyes of the user relative to the head-mounted enclosure; determining 540 respective three dimensional transforms for respective virtual cameras associated with the one or more eyes of the user; determining 550 distortion maps for one or more eyes of the user and an optical assembly of the head-mounted enclosure; and transmitting 560 data based on the positions and/or the orientations of the one or more eyes to a display device that is mounted in the head-mounted enclosure. For example, the process 500 may be implemented by the personal computing device 230 of FIG. 2. For example, the process 500 may be implemented by the system 300 of FIG. 3.

The process 500 includes capturing 510 a set of images that depict a face of a user (e.g., the user 110) and a head-mounted enclosure (e.g., the head-mounted enclosure 120) that the user is wearing. By depicting both the face of the user and the head-mounted enclosure worn by the user, the set of images conveys information regarding the position of one or more eyes of the user relative to the head-mounted enclosure. For example, the set of images may be captured by an image sensor in a device (e.g., the personal computing device 230) held in a hand of the user (e.g., as illustrated in FIG. 2). For example, the user may hold the device in their hand and point the image sensor at their head while capturing 510 the set of images. In some implementations, the user may turn their head and/or move their hand along an arc around their head to capture 510 images with a diversity of perspectives of the face and the head-mounted enclosure. For example, the one or more image sensors 330 of FIG. 3 may be used to capture 510 the set of images. For example, the set of images may include visible spectrum color (e.g., RGB or YUV) images and/or infrared images.

The process 500 includes determining 520, based on the set of images, a first position of a first eye (e.g., the right eye 114) of the user relative to the head-mounted enclosure. Determining 520 the first position may include tracking the face of the user in the set of images and/or tracking the first eye using computer vision processing applied to the set of images. In some implementations, the position of the first eye may be determined 520 based in part on prior registered geometric model of the face of the user and tracking a collection of one or more other features of the face. For example, the process 600 of FIG. 6 may be implemented to determine 520 the first position of the first eye relative to the head-mounted enclosure. Determining 520 the first position may include tracking the head-mounted enclosure in the set of images using computer vision processing applied to the set of images. In some implementations, a marker (e.g., the displayed marker or a physical marker feature) located on the head-mounted display is tracked to facilitate accurate tracking of a relevant portion of the head mounted enclosure. For example, the first position of the first eye may be determined 520 based on comparison of tracking data for first eye and tracking data for a marker (e.g., the marker 160) on the head-mounted display. The first position of the first eye may be encoded as a three dimensional vector in a coordinate system of the head-mounted enclosure. The first position of the first eye may be an offset from an origin point in the coordinate system of the head-mounted enclosure. The process 500 may also include determining 520, based on the set of images, a second position of a second eye (e.g., the left eye 116) of the user relative to the head-mounted enclosure. The second position of the second eye may be determined 520 using techniques applied to the set of images that are the same or similar to the techniques used to determine 520 the first position of the first eye. For example, the process 600 of FIG. 6 may be implemented to determine 520 the second position of the second eye relative to the head-mounted enclosure.

The process 500 includes determining 530, based on the set of images, a first orientation of the first eye (e.g., the right eye 114) of the user relative to the head-mounted enclosure. The process 500 may also include determining 530, based on the set of images, a second orientation of the second eye (e.g., the left eye 116) of the user relative to the head-mounted enclosure. For example, determining 530 an orientation of an eye may include tracking a pupil of the eye relative to one or more other features of the face of the user. For example, an orientation of an eye may be encoded as three-tuple of Euler angles or a quaternion expressed in a coordinate system of the head-mounted enclosure.

The process 500 includes determining 540, based on the first position, a first three-dimensional transform for a first virtual camera associated with the first eye. The process 500 may include determining 540, based on the second position, a second three-dimensional transform for a second virtual camera associated with the second eye. For example, the one or more three-dimensional transforms may respectively be encoded as 4×4 3-D transformation matrices. For example, the one or more three-dimensional transforms may include a perspective projection matrix. For example, the first three-dimensional transform and/or the second three-dimensional transform may be determined 540 relative to an origin of calibration in a coordinate system of the head-mounted enclosure. In some implementations, determining 540 a three dimensional transform for an eye includes retrieving a pre-calculated transform from a look-up table that is indexed by a quantized version of the position of the eye relative to the head-mounted enclosure. In some implementations, the first three-dimensional transform is determined 540 based on the orientation of the first eye, in addition to the position of the first eye. In some implementations, the second three-dimensional transform is determined 540 based on the orientation of the second eye, in addition to the position of the second eye.

The process 500 includes determining 550, based on the first position, a first distortion map for the first eye and an optical assembly (e.g., a lens) of the head-mounted enclosure. The process 500 may include determining 550, based on the second position, a second distortion map for the second eye and an optical assembly (e.g., a lens) of the head-mounted enclosure. In some implementations, determining 550 a distortion map for an eye includes retrieving a pre-calculated distortion map from a look-up table that is indexed by a quantized version of the position of the eye relative to the head-mounted enclosure. In some implementations, the first distortion map is determined 540 based on the orientation of the first eye, in addition to the position of the first eye. In some implementations, the second distortion map is determined 540 based on the orientation of the second eye, in addition to the position of the second eye.

The process 500 includes transmitting 560 data based on the first position and the second position to a display device (e.g., the display device 124) that is mounted in the head-mounted enclosure. In some implementations, the data based on the first position and the second position may include the first position and the second position encoded as three-dimensional vectors in a coordinate system of the head-mounted enclosure. In some implementations, the data based on the first position and the second position may include the first three-dimensional transform and/or the second three-dimensional transform encoded as matrices. In some implementations, the data based on the first position and the second position may include the first distortion map and/or the second distortion map. A device (e.g., the personal computing device 230) implementing the process 500 and a display device (e.g., the display device 124) may communicate through multi-peer connectivity. For example, a QR code (e.g., presented by the display device) may be used to facilitate multi-peer connectivity in finding a correct device to communicate with. For example, the data may be transmitted 560 via the wireless communications interface 340 of FIG. 3.

The process 500 may be modified to reorder, replace, add, or omit steps included in FIG. 5. For example, transmitting 560 data based on the first position and the second position to a display device may be omitted or replaced with storing data based on the first position and the second position, where a device used to capture the set of images is also used as a display device (e.g., by mounting the device in the head-mounted enclosure after the eye enrollment process is completed). For example, determining 530 orientations of one or more eyes may be omitted. For example, determining 540 three-dimensional transforms and determining 550 distortion maps may be omitted and/or instead performed by the display device receiving the data based on the first position and the second position that will use this calibration data to present images to the user wearing the head-mounted enclosure.

FIG. 6 is a flowchart of an example of a process 600 for determining a position for one or more eyes of a user (e.g., the user 110) relative to a head-mounted enclosure (e.g., the head-mounted enclosure 120). The process 600 includes determining 610, based on the set of images, a third position of another facial feature of the user relative to the head-mounted enclosure; accessing a facial geometry model for the user; determining the positions of the one or more eyes (e.g., the right eye 114 and/or the left eye 116) based on the third position and the facial geometry model. By using the positions of other facial features to estimate the positions of the eyes, the enrollment process can function in cases where the head-mounted display partially or completely obscures the eyes (e.g., where the optical assembly is completely or partially opaque) in the set of images captured for eye enrollment. For example, the process 600 may be implemented by the display device 124 of FIG. 1. For example, the process 600 may be implemented by the personal computing device 230 of FIG. 2. For example, the process 600 may be implemented by the system 300 of FIG. 3.

The process 600 includes determining 610, based on the set of images, a third position of another facial feature (e.g., a nose, an ear, or a mouth) of the user relative to the head-mounted enclosure. Determining 610 the third position may include tracking the face of the user in the set of images and/or tracking the facial feature using computer vision processing applied to the set of images. The third position of the facial feature may be encoded as a three dimensional vector. The third position of the facial feature may be an offset from an origin point in a coordinate system of the head-mounted enclosure or in a coordinate system of a device performing an eye enrollment process (e.g., from in the hand of the user wearing the head-mounted enclosure).

The process 600 includes accessing 620 a facial geometry model for the user. For example, the facial geometry model for the user may have been previously determined and stored during a facial biometric profile registration process for the user. For example, the facial geometry model may be retrieved from a data storage device (e.g., the data storage device 320).

The process 600 includes determining 630 the first position (e.g., of the right eye 114) based on the third position and the facial geometry model. The process 600 may include determining 630 the second position (e.g., of the left eye 116) based on the third position and the facial geometry model. Determining 630 the first position may include determining and orientation of the face and adding a vector associated with the first eye and the other facial feature from the geometric facial model to the third position. Determining 630 the second position may include determining and orientation of the face and adding a vector associated with the second eye and the other facial feature from the geometric facial model to the third position.

FIG. 7 is a flowchart of an example of a process 700 for presenting images to a user (e.g., the user 110) via an optical assembly (e.g., the optical assembly 126) of a head-mounted enclosure (e.g., the head-mounted enclosure 120), using eye enrollment data. The process 700 includes receiving 710 data based on the positions and/or the orientations of the eyes of the user; accessing 720 a three-dimensional transform for respective virtual cameras associated with the eyes; applying 730 the three-dimensional transform to an image to obtain a transformed image; accessing 740 a distortion map for respective eyes and the optical assembly; applying 750 a transformation based on the distortion map to an image to obtain a transformed image; and projecting 760 a respective transformed image from a display, via the optical assembly of the head-mounted enclosure, to a respective eye of the user. For example, the process 700 may be implemented by the display device 124 of FIG. 1. For example, the process 700 may be implemented by the system 400 of FIG. 4.

The process 700 includes receiving 710 data based on the positions and/or the orientations of the eyes of the user. In some implementations, the data based on the positions and/or the orientations of the eyes of the user may include a first position of a first eye (e.g., the right eye 114) and a second position of a second eye (e.g., the left eye 116). For example, the first position and the second position may be encoded as three-dimensional vectors in a coordinate system of the head-mounted enclosure. In some implementations, the data based on the positions and/or the orientations of the eyes of the user may include a first three-dimensional transform for the first eye and/or a second three-dimensional transform for the second eye that are encoded as matrices. In some implementations, the data based on the positions and/or the orientations of the eyes of the user may include a first distortion map for the first eye and/or a second distortion map for the second eye. For example, the data based on the positions and/or the orientations of the eyes of the user may be received 710 from a device (e.g., the personal computing device 230) that has performed an eye enrollment process (e.g., the process 500 of FIG. 5). For example, the data based on the positions and/or the orientations of the eyes of the user may be received 710 using the wireless communication interface 440 of FIG. 4.

The process 700 includes accessing 720 one or more three-dimensional transforms for respective virtual cameras associated with respective eyes of the user. The processing to determine the one or more three-dimensional transforms may be distributed between the sending device (e.g., the personal computing device 230) and the receiving device (e.g., the display device 124) in various ways. For example, the accessing 720 the one or more three-dimensional transforms may include reading the one or more three-dimensional transforms in a message received 710 from a device that performed an eye enrollment process (e.g., the process 500 of FIG. 5). For example, the one or more three-dimensional transforms may be retrieved from a data storage device (e.g., the data storage device 420). For example, the accessing 720 the one or more three-dimensional transforms may include determining (e.g., as described in relation to step 540 of FIG. 5) the one or more three-dimensional transforms based on data, including positions and/or orientations for the eyes, received 710 from a device (e.g., the personal computing device 230) that has performed an eye enrollment process.

The process 700 includes applying 730 the one or more three-dimensional transforms to an image to obtain a transformed image. For example, the process 700 may include applying 730 the first three-dimensional transform to an image to obtain a first transformed image (e.g., for the right eye 114), and applying 730 the second three-dimensional transform to an image to obtain a second transformed image (e.g., for the left eye 116).

The process 700 includes accessing 740 one or more distortion maps for respective eyes of the user and the optical assembly. The processing to determine the one or more distortion maps may be distributed between the sending device (e.g., the personal computing device 230) and the receiving device (e.g., the display device 124) in various ways. For example, the accessing 720 the one or more distortion maps may include reading the one or more distortion maps in a message received 710 from a device that performed an eye enrollment process (e.g., the process 500 of FIG. 5). For example, the one or more three-dimensional transforms may be retrieved from a data storage device (e.g., the data storage device 420). For example, the accessing 720 the one or more distortion maps may include determining (e.g., as described in relation to step 550 of FIG. 5) the one or more distortion maps based on data, including positions and/or orientations for the eyes, received 710 from a device (e.g., the personal computing device 230) that has performed an eye enrollment process.

The process 700 includes applying 750 a transformation based on the distortion map to an image to obtain a transformed image. For example, the process 700 may include applying 750 a transformation based on the first distortion map to an image to obtain a first transformed image (e.g., for the right eye 114), and applying 750 the a transformation based on the second distortion map to an image to obtain a second transformed image (e.g., for the left eye 116).

The process 700 includes projecting 760 the transformed image from a display (e.g., the display 430), via an optical assembly (e.g., the optical assembly 126) of the head-mounted enclosure, to the first eye (e.g., the right eye 114). The process 700 may include projecting 760 the second transformed image from the display, via the optical assembly of the head-mounted enclosure, to the second eye (e.g., the left eye 116).

The process 700 may be modified to reorder, replace, add, or omit steps included in FIG. 7. For example, receiving 710 data based on the positions and/or the orientations of the eyes may be omitted or replaced with accessing data based on the first position and the second position, where a device used to capture the set of images is also used as a display device (e.g., by mounting the device in the head-mounted enclosure after the eye enrollment process is completed). For example, accessing 740 and applying 750 the one or more distortion maps may be omitted.

Physical Environment
a. A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-Generated Reality
a. In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).
b. A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.
c. Examples of CGR include virtual reality and mixed reality.

Virtual Reality
a. A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment

Mixed Reality
a. In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.
b. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.
c. Examples of mixed realities include augmented reality and augmented virtuality.
d. Augmented reality
   i. An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.
   ii. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.
e. Augmented virtuality
   i. An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, hut people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware

There are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone).

As described above, one aspect of the present technology is the gathering and use of data available from various sources to improve the image quality and the user experience. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to tailor images displayed in a head-mounted enclosure for the topology of a user's head. Further, other uses for personal information data that benefit the user are also contemplated by the present disclosure. For instance, health and fitness data may be used to provide insights into a user's general wellness, or may be used as positive feedback to individuals using technology to pursue wellness goals. The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country. Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, a head-mounted enclosure may be configured based on non-personal information data or a bare minimum amount of personal information, such as the content being requested by the device associated with a user, other non-personal information available to the head-mounted enclosure, or publicly available information.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. A system comprising:
an image sensor; and
a processing apparatus configured to:
access a set of images, captured using the image sensor, that depict a face of a user and a head-mounted enclosure that the user is wearing; and
determine, based on the set of images, a first position of a first eye of the user relative to the head-mounted enclosure.

2. The system of claim 1, wherein the processing apparatus that is configured to:
determine, based on the set of images, a second position of a second eye of the user relative to the head-mounted enclosure.

3. The system of claim 1, wherein the processing apparatus is configured to:
determine, based on the set of images, a first orientation of the first eye of the user relative to the head-mounted enclosure.

4. The system of claim 1, wherein the processing apparatus is configured to:
determine, based on the first position, a three-dimensional transform for a first virtual camera associated with the first eye.

5. The system of claim 4, comprising a display and wherein the processing apparatus is configured to:
apply the three-dimensional transform to an image to obtain a transformed image; and
project the transformed image from the display, via an optical assembly of the head-mounted enclosure, to the first eye.

6. The system of claim 1, wherein the processing apparatus is configured to:
determine, based on the first position, a distortion map for the first eye and an optical assembly of the head-mounted enclosure.

7. The system of claim 6, comprising a display and wherein the processing apparatus is configured to:
apply a transformation based on the distortion map to an image to obtain a transformed image; and
project the transformed image from the display, via an optical assembly of the head-mounted enclosure, to the first eye.

8. The system of claim 1, wherein the processing apparatus is configured to determine the first position by performing operations including:
determining, based on the set of images, a second position of another facial feature of the user relative to the head-mounted enclosure;
accessing a facial geometry model for the user; and
determining the first position based on the second position and the facial geometry model.

9. The system of claim 1, comprising a wireless communications interface and wherein the processing apparatus is configured to:
transmit data based on the first position to a display device that is mounted in the head-mounted enclosure.

10. A method comprising:
capturing a set of images that depict a face of a user and a head-mounted enclosure that the user is wearing;
determining, based on the set of images, a first position of a first eye of the user relative to the head-mounted enclosure; and
determining, based on the set of images, a second position of a second eye of the user relative to the head-mounted enclosure.

11. The method of claim 10, comprising:
determining, based on the set of images, a first orientation of the first eye of the user relative to the head-mounted enclosure; and
determining, based on the set of images, a second orientation of the second eye of the user relative to the head-mounted enclosure.

12. The method of claim 10, comprising:
determining, based on the first position, a three-dimensional transform for a first virtual camera associated with the first eye.

13. The method of claim 12, comprising:
applying the three-dimensional transform to an image to obtain a transformed image; and
projecting the transformed image from a display, via an optical assembly of the head-mounted enclosure, to the first eye.

14. The method of claim 10, comprising:
determining, based on the first position, a distortion map for the first eye and an optical assembly of the head-mounted enclosure.

15. The method of claim 14, comprising:
applying a transformation based on the distortion map to an image to obtain a transformed image; and
projecting the transformed image from a display, via an optical assembly of the head-mounted enclosure, to the first eye.

16. The method of claim 10, wherein determining the first position and the second position comprises:
determining, based on the set of images, a third position of another facial feature of the user relative to the head-mounted enclosure;
accessing a facial geometry model for the user;
determining the first position based on the third position and the facial geometry model; and
determining the second position based on the third position and the facial geometry model.

17. The method of claim 10, comprising:
transmitting data based on the first position and the second position to a display device that is mounted in the head-mounted enclosure.

18. The method of claim 10, wherein the set of images is captured by an image sensor in a device held in a hand of the user.

19. A system comprising:
a head-mounted enclosure, including a lens;
a display; and
a processing apparatus configured to:
access a first three-dimensional transform for a first virtual camera associated with a first eye of a user that is wearing the head-mounted enclosure, wherein the first three-dimensional transform has been determined based on a position of the first eye relative to the head-mounted enclosure;
access a second three-dimensional transform for a second virtual camera associated with a second eye of the user, wherein the second three-dimensional transform has been determined based on a position of the second eye relative to the head-mounted enclosure;
apply the first three-dimensional transform to an image to obtain a first transformed image;
project the first transformed image from the display, via the lens of the head-mounted enclosure, to the first eye;
apply the second three-dimensional transform to an image to obtain a second transformed image; and
project the second transformed image from the display, via the lens of the head-mounted enclosure, to the second eye.

20. The system of claim 19, wherein the processing apparatus is configured to:
access a first distortion map for the first eye and the lens of the head-mounted enclosure;
access a second distortion map for the second eye and the lens of the head-mounted enclosure;
apply a transformation based on the first distortion map to an image to obtain the first transformed image; and
apply a transformation based on the second distortion map to an image to obtain the second transformed image.
